(19) United States
(12) Patent Application Publication
(10) Pub. No.: US 2005/0108904 A1
(43) Pub. Date: May 26, 2005

(54) Sticky calendar

(76) Inventor: Sarah A. Green, Kenner, LA (US)

Correspondence Address: Sarah A. Green, 3132 Acron Street, Kenner, LA, 70065, US

(21) Appl. No.: 10/864,090

(22) Filed: Jun. 8, 2004

Related U.S. Application Data
(60) Provisional application No. 60/523,285, filed on Nov. 20, 2003.

(51) Int. Cl. G09D 3/00; G09F 7/12

(52) U.S. Cl. 40/107; 40/594

(57) ABSTRACT

The Sticky Calendar is a wall calendar in which an adhesive is used for holding the calendar on the wall instead of many traditionally used holding devices such as pushpins, thumbtacks, or nails. Additionally, the Sticky Calendar features an additional adhesive which runs along the bottom of each month's calendar page to hold the previous month's calendar pages up to reveal the new month's page with a removable strip covering the adhesive.

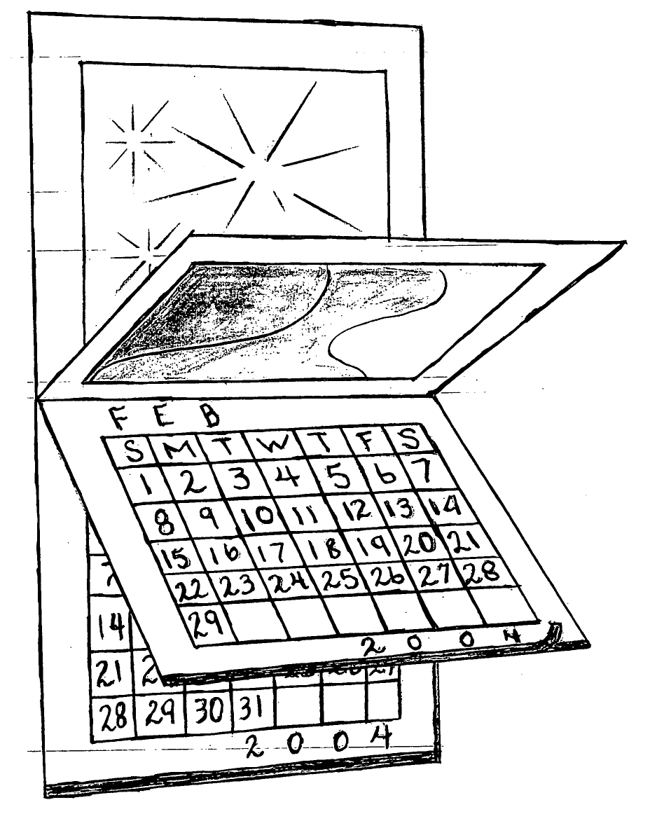

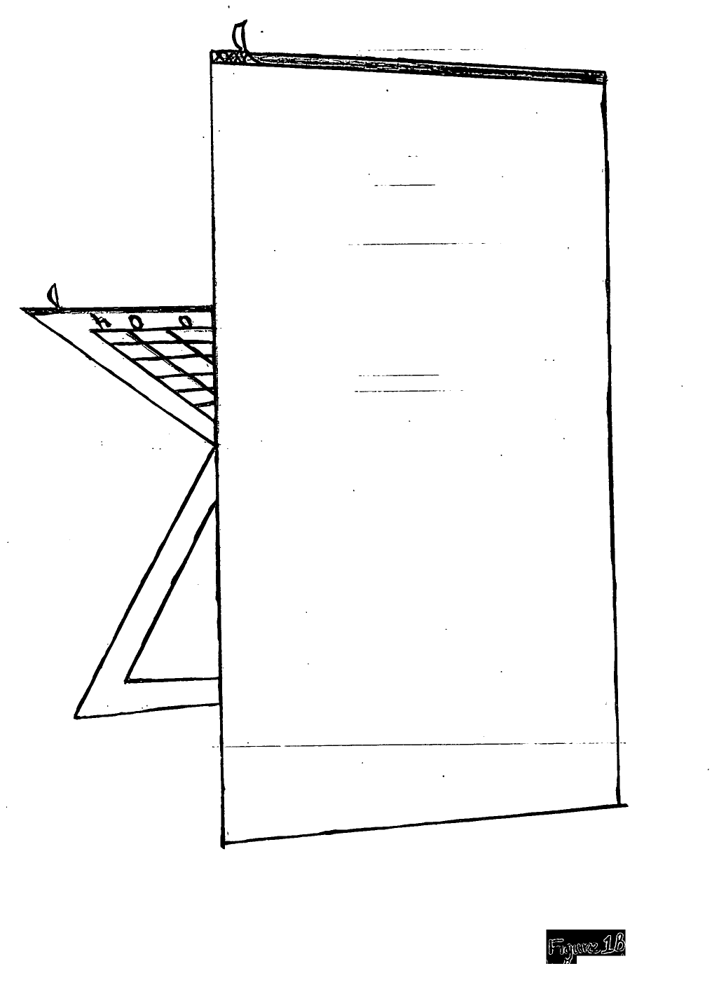

### CROSS-REFERENCE TO RELATED APPLICATIONS

This non provisional utility patent application is preceded by and takes priority over a provisional patent application granted on Nov. 20, 2003 for the same invention entitled, “The Sticky Calendar”. Please refer to provisional application filing number, 60/523,285.

On view of a normal top to bottom elongated wall calendar, the Sticky Calendar features an adhesive strip, whether: tape, glue, wax, or any other adhesive material, and a removable strip covering located in two places. The first adhesive strip with removable covering is found along the upper outer edge of the calendar and is used for wall hanging. The second place the adhesive strips with removable covering are found is along the bottom edge of the bottom pages of the opened elongated wall calendar. At the beginning of each new month, the removable strip covering is removed to reveal the adhesive and the preceding month's page is flipped forward and up to hold in place and reveal the new month's calendar page.

### STATEMENT REGARDING FEDERALLY SPONSORED RESEARCH OR DEVELOPMENT

N/A

### REFERENCE TO A SEQUENCE LISTING, A TABLE, OR A COMPUTER PROGRAM LISTING COMPACT DISC APPENDIX

N/A

### BACKGROUND OF THE INVENTION

The Sticky Calendar falls within the field of endeavor of the stationary and paper products industry.

28 WITH CALENDAR INDICATOR: This subclass is indented under the class definition. Subject matter including means for indicating days of the week, weeks of the month, months of the year, years or any other man-made divisions of time wherein the lowest time period unit indicated is at least equal to the time of one revolution of the earth on its axis.

Specific past problems with this art:

The Sticky Calendar is a new idea which will revolutionize calendar usage. In the past, wall calendars have required either a nail, pushpin, or thumbtack etc . . . to hold them on a wall. These holding devices required that the calendar user put a hole in his wall to hold the calendar in place. The Sticky Calendar eliminates the necessity for wall calendar users to create a hole in their walls to hold their calendars up, as an adhesive is used instead of a nail, pushpin, or thumbtack. Additionally, multiple holes may be created in a wall using the above mentioned holding devices. Often when a pushpin or thumbtack is used, when the month changes and the calendar page has to be flipped forward and up to hold, the calendar user may have to create another hole in the wall because the previous hole has become too big to hold the pushpin or thumbtack despite it just having been removed. The Sticky Calendar's adhesive strip along the bottom of the bottom front page is flipped forward and up to hold the previous month's calendar page up and reveal the new month's page, eliminating the possibility of creating additional holes in a wall.

### BRIEF SUMMARY OF THE INVENTION

The Sticky Calendar is a wall calendar in which an adhesive is used for holding the calendar on the wall instead of many traditionally used holding devices such as pushpins, thumbtacks, or nails. Additionally, the Sticky Calendar features an additional adhesive which runs along the bottom of each month's calendar page to hold the previous month's calendar pages up to reveal the new month's page with a removable strip covering the adhesive.

The Sticky Calendar eliminates the necessity for wall calendar users to create a hole in their walls to hold their calendars up, as an adhesive is used instead of a nail, pushpin, or thumbtack. Additionally, The Sticky Calendar prevents multiple holes being created monthly, as is apt to happen, with the above mentioned holding devices. Often when a pushpin or thumbtack is used, when the month changes and the calendar page has to be flipped forward and up to hold. The calendar user may have to create another hole in the wall because the previous hole has become too big to hold the pushpin or thumbtack despite it just having been removed. The Sticky Calendar's adhesive strip along the bottom of the bottom front page is flipped forward and up to hold the previous month's calendar page up and reveal the new month's page, eliminating the possibility of additional holes being created in the wall.

### BRIEF DESCRIPTION OF THE SEVERAL VIEWS OF THE DRAWING

FIG. IA.

1.) Illustration of adhesive of the Sticky Calendar. The adhesive holds the calendar page up.

2.) Illustration of removable strip covering for the adhesive for the Sticky Calendar.

3.) The changing month's calendar page. The page being flipped forward and up for holding.

4.) The new calendar month's page to be revealed(March).

5.) Calendar picture and illustration.

6.) Illustration of a full frontal view of the elongated Sticky Calendar.

FIG. IB

1.) Adhesive used for holding the entire weight of the calendar on the wall.

2.) Removable strip covering for adhesive.

3.) Elongated fall back view of the Sticky Calendar.

### DETAILED DESCRIPTION OF THE INVENTION

The Sticky Calendar features:

On view of a normal top to bottom elongated wall calendar, the Sticky Calendar features an adhesive strip whether, glue, tape, wax, or the like, with a removal tape covering made of wax or any other removable material, along the upper outer edge of the calendar and is used for wall hanging. Along the bottom edge of the bottom page of the opened elongated calendar month's page runs an adhesive with removal tape covering made of wax or any other removable material. At the beginning of each new month, the removable tape covering is removed and the preceding month's page is flipped forward and up to hold and reveal the new month's calendar page.

The Process of making the Sticky Calendar involves implanting an adhesive material such as double-sided tape, glue, wax, or any other adhesive material along with a removable strip covering for the adhesive made of wax paper or any other removable material, along the upper outer edge of an elongated wall calendar and along the bottom of the bottom page of an elongated wall calendar. The removable strips covering the adhesives in the above mentioned positions are removed to reveal the adhesive material and the adhesive is used to either hang the calendar on the wall or other surface and the calendar's monthly pages which are flipped forward and up monthly to hold and reveal each new month's calendar page.

1. What I claim as my invention is the use of an adhesive material, whether glue, tape, wax, or the like, double-sided or not, used and or positioned in the upper outer edge of an elongated wall calendar for the purpose of holding the calendar in place on a wall or other surface; and or the use of an adhesive material, whether glue, tape, wax, or the like positioned along the bottom edge of the bottom page of an elongated wall calendar used as a holding agent for holding a calendar page forward an upward for the purposes of hiding a previous month's calendar page and revealing a new month's calendar page: Additionally I claim as my invention the use of a removable strip covering made of wax or any other material used as a covering for the adhesive strip previously mentioned above in any of the named positions and or for the purposes mentioned above on a wall calendar.
